(19) United States
(12) Patent Application Publication
(10) Pub. No.: US 2019/0057346 A1
(43) Pub. Date: Feb. 21, 2019

(54) PROGRESS-BASED LOAD DELIVERY SETTLEMENT SYSTEM

(71) Applicants: Christian Schenk, Waconia, MN (US); Dimitrios Karameris, New York, NY (US); Keith McKenzie, Miami Beach, FL (US); Ryan Deslippe, Miami Beach, FL (US); Michael Stepaniak, Plymouth, MN (US); Jacob Dettmer, Chaska, MN (US); Amanda Ford, Waconia, MN (US); Alex Parker, Chaska, MN (US)

(72) Inventors: Christian Schenk, Waconia, MN (US); Dimitrios Karameris, New York, NY (US); Keith McKenzie, Miami Beach, FL (US); Ryan Deslippe, Miami Beach, FL (US); Michael Stepaniak, Plymouth, MN (US); Jacob Dettmer, Chaska, MN (US); Amanda Ford, Waconia, MN (US); Alex Parker, Chaska, MN (US)

(21) Appl. No.: 15/688,413

(22) Filed: Aug. 28, 2017

Related U.S. Application Data
(60) Provisional application No. 62/546,244, filed on Aug. 16, 2017.

(51) Int. Cl. G06Q 10/08; G01S 19/42; G06F 3/0488; G06Q 20/10

(52) U.S. Cl. CPC G06Q 10/0833; G06Q 10/0875; G06Q 20/102; G06F 3/0488; G01S 19/42

(57) ABSTRACT

Systems and methods may be used to determine, allocate, and receive a progress-based load delivery settlement. A method may include activating a progress-based load delivery settlement session for a carrier account corresponding to a carrier. The method may include transmitting or receiving, in response information, such as from a GPS unit indicating that a load has been picked up by the carrier, a first percentage of a settlement to the carrier account. The method may include transmitting or receiving, in response information, such as from a GPS unit indicating that the carrier has passed a milestone, a second percentage of the settlement in the carrier account.

### CLAIM OF PRIORITY

This application claims the benefit of priority to U.S. Provisional Application No. 62/546,224, filed Aug. 16, 2017, titled “Progress-Based Load Delivery Settlement System”, which is hereby incorporated herein by reference in its entirety.

### BACKGROUND

Trucking companies and drivers often must pay bills or expenses related to operation of trucks before payment is received for delivery of loads. Payment for load delivery often takes 30 to 40 days for processing before the company or driver receives the payment. Some companies or drivers use factoring services, which can be costly. These services may provide capital, however they do not provide banking services.

Further, truck drivers cannot physically access banks while driving their trucks due to physical limitations of bank branches and the size of most trucks. Current online or mobile banking solutions are for the general public and do not address the particularities of the trucking industry. One drawback to these solutions is that they do not permit payment to be received for delivery of a load before the delivery is completed. These solutions also do not allow drivers to allocate funds to family members while a delivery is in progress.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a load settlement timeline in accordance with some embodiments.

FIGS. 2A-2F illustrate example user interface elements for a progress-based load delivery settlement system in accordance with some embodiments.

FIG. 3 illustrates an example distribution schedule map and table for progress-based load delivery settlement in accordance with some embodiments.

FIGS. 4A-4C illustrate example web-based user interface for a progress-based load delivery settlement system in accordance with some embodiments.

FIG. 5 illustrates a flowchart showing a technique for progress-based load delivery settlement in accordance with some embodiments.

FIG. 6 illustrates generally an example of a block diagram of a machine upon which any one or more of the techniques (e.g., methodologies) discussed herein may perform in accordance with some embodiments.

### DETAILED DESCRIPTION

Systems and methods for providing progress-based load delivery settlements are described herein. The systems and methods described herein allow a driver to receive partial settlement of a contract for a load before delivery. As described above, trucking companies and drivers often must pay bills or expenses, such as purchasing fuel to deliver a load before payment is received for the delivery. Payment for load delivery is usually made upon completion of the delivery, but costs for delivering the load may be incurred before the delivery is started or along a delivery route. Although these costs may be covered by the settlement received at the completion of the delivery, the timing of the costs coming before the payment causes hardships for drivers, often leading to loans, which may have high interest rates. In another example, a driver may not be able to accept a load when the driver is unable to pay for the costs or expenses ahead of time.

One risk factor of paying drivers up front, or loaning a driver money based on a load settlement payment, is that the driver may not use the money received to pay for the expenses of the load delivery. The systems and methods described herein allow for a partial payment to be made to a driver before delivery of a load is completed based on a settlement value of a contract for delivery of the load. The partial payment may have a restricted use for the drive (e.g., for spending on fuel or a hotel stay), or may be unrestricted. The partial payment may be based on milestones (e.g., driving a predetermined distance) completed by the driver, such as with a partial payment corresponding to completion of a milestone. The partial payment may be made to an account associated with a card, where the card may have restrictions on use, or the account may have restrictions on transfers. The card may include deals or discounts for use of the card at specified locations or for predetermined purposes. The card may be used like a credit card, a debit card, or an automated teller machine (ATM) card, and the use may change depending on account type, balance, milestones completed, outstanding bills, etc. The card may include liability protection against unauthorized purchases or ATM transactions.

To provide the services described herein, the present systems and methods generate a session for an account of a driver. The session may be a session for an account specific to a progress-based payment load delivery, for example, the session may be a progress-based payment session that may start when a load is selected, picked up, or when the session is activated, and may end when the load is delivered, paperwork is completed, or the session is deactivated. The session may include sending or receiving progress-based payments. A progress-based payment may be a percentage of a total settlement value for delivery of a load or a percentage of a total settlement value after deduction of a fee. The progress-based payment may be made based on a milestone reached by the driver while traversing a route from pickup of the load to completion of delivery of the load, or based on events, such as pickup completion, delivery completion, paperwork completion, etc. The milestones may include a number of miles along the route. The route may be a truck-passable route no truck restrictions, bridge decks below a certain height, weather conditions, etc.) such that the number of miles, location of the milestone, or the route may vary depending on road conditions. A map or list may be displayed on a user interface, which may include the route, one or more milestones, events, deals, discounts, points of interest, or the like.

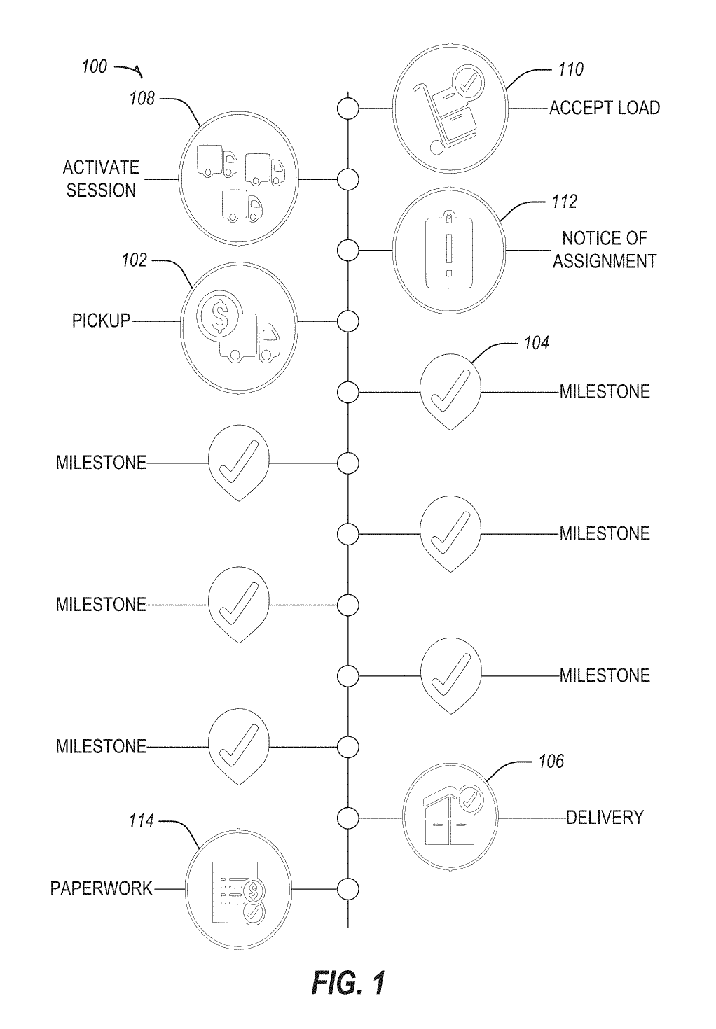

FIG. 1 illustrates a load settlement timeline 100 in accordance with some embodiments. The load settlement timeline 100 includes a plurality of milestones, which may also be referred to as events. The plurality of milestones include pickup of the load 102, at least one progress-based milestone 104, and load delivery completion 106. The load settlement timeline 100 may include milestones such as, a load acceptance milestone 110, a notice of assignment milestone 112, or a paperwork milestone 114. The load settlement timeline 100 may include an activate session milestone 108. The various milestones described along the load settlement timeline 100 may occur in an order different than that depicted in FIG. 1. For example, the activate session 108 milestone may occur after notice of assignment 112 or after pickup 102. The various milestones described along the load settlement timeline 100, when achieved, may trigger a payment, such as according to terms of a progress-based settlement session. Other milestones may not trigger a payment (e.g., activate session 108).

In an example, the load settlement timeline 100 may correspond to actions taken by a driver. The driver may accept a load 110, which may trigger a session to activate 108 for an account of the driver. The driver may pick up the load 102 to deliver along a route. The route may include a plurality of milestones (e.g., 104), which, when the driver passes with the load along the route, may trigger a payment to the account of the driver. The milestone may be determined as passed using a global positioning system (GPS) unit, such as located on a truck driving the load, with the load, with the driver (e.g., a mobile device), etc., a landmark (e.g., a weigh station), or other location based services. When the driver passes a milestone (e.g., 104), a payment may be applied to the driver's account. For example, the payment may be a percentage of a settlement amount for delivery of the load (the settlement amount may exclude a fee).

When the driver completes delivery 106, a payment may be made. After delivery, paperwork 114 is typically filled out (e.g., by a party that accepted the load, the driver, a contracting party, etc.). In an example, the paperwork 114 is completed, a final payment may be made. In another example, the final payment may be made upon completion of delivery. In yet another example, the final payment may be made based on a milestone completion or after a period of time after some milestone or event is completed.

In an example, the notice of assignment 112 event may include sending the driver an indication (e.g., via a user interface of an app) that the settlement for the contract has been assigned and will be paid to a progress-based payment entity. In exchange, the progress-based payment entity may agree to pay a percentage of the settlement to the driver based on the driver passing milestones or completing events (e.g., pickup, 100 miles driven, delivery, etc.). The percentage of the settlement may include progress-based payments, which may be tied to a specific account, card, or to the driver.

After receiving payment, the driver may have access to funds instantly. The funds may be transferable to subordinate accounts, used to pay bills, transferred to an outside bank account, used as a credit or debit card (e.g., to pay for fuel or a hotel), or the like. In some cases, use of the funds may be restricted. For example, use may be restricted to costs related to delivery of the load (e.g., fuel, food, insurance, etc.), or a predetermined amount may be restricted (e.g., up to 50% may be transferred to another account).

In an example, a carrier (including a driver or a fleet manager) may accept a load from a shipper or broker at 110 including a contract with a settlement amount. The carrier may choose to activate a session for progress-based payments at 108. The carrier may receive a notice of assignment at 112, indicating that the settlement amount will go to a progress-based payment entity. When the carrier is a fleet manager, the fleet manager may assign or accept a driver for delivery of the load. The driver picks up the load from the shipper or broker at 102. The driver may receive a payment from the progress-based payment entity in response to picking up the load. In an example, the payment may be triggered by the shipper or broker indicating to the progress-based payment entity (e.g. directly to the progress-based payment entity or via the driver) that the load has been picked up. In another example, the driver may indicate to the progress-based payment entity that the load has been picked up. In yet another example, a GPS or other location-based service may be used by the progress-based payment entity to determine that the driver has picked up the load. The payment received by the driver may be a percentage of the settlement amount, for example minus a fee, such as 20%.

After picking up the load, The driver may proceed along a route to deliver the load. The route may include milestones, and after passing each milestone (e.g., 100 miles passed), a percentage of the settlement may be sent to the driver (e.g., 60% of the settlement value divided by the number of milestones along the route), such as milestone 104. The milestones may be identified to the driver using a user interface of an app or website. For example, a map may be displayed including the route on a mobile app. In an example, a list of milestones may be displayed on the user interface.

The list or map may include points of interest, such as the milestones, truck stops, refueling locations, rest stops, weigh stations, restaurants, weather reports, construction information, or the like. To determine when a milestone is passed by the driver with the load, a GPS or other location identifying device or service may be used. For example, the load may include a GPS device specific to the load that identifies the location of the load during the delivery and along the route. In another example, a mobile device of the driver may be used (e.g., the mobile device running the mobile app used to display the list or map).

In an example, the final milestone may be the delivery point 106. At the delivery point, the load may be transferred to a receiver. In an example, paperwork may be sent to the progress-based payment entity to indicate that the delivery has been completed by the driver. The paperwork may be sent by the receiver directly to the progress-based payment entity or via the driver (e.g., via the mobile app). In another example, the driver may complete the paperwork and send it to the progress-based payment entity. After the paperwork is completed and sent to the progress-based payment entity, the progress-based payment entity may check the paperwork, and when accepted, send a final payment to the driver at 114. The final payment may be a remaining percentage (e.g., 20%) of the settlement due to the driver.

The load settlement timeline 100 may represent a per-delivery or route-based session 108. For example, a driver may assign the settlement at the time the delivery is picked up at 102, when activating the session 108, or when accepting the load at 110. The driver may not be required to use the progress-based payment structure for any other loads to be delivered or delivered in the past. The progress-based payment structure may be used for the load delivery as a stand-alone contract, such as using the notice of assignment 112.

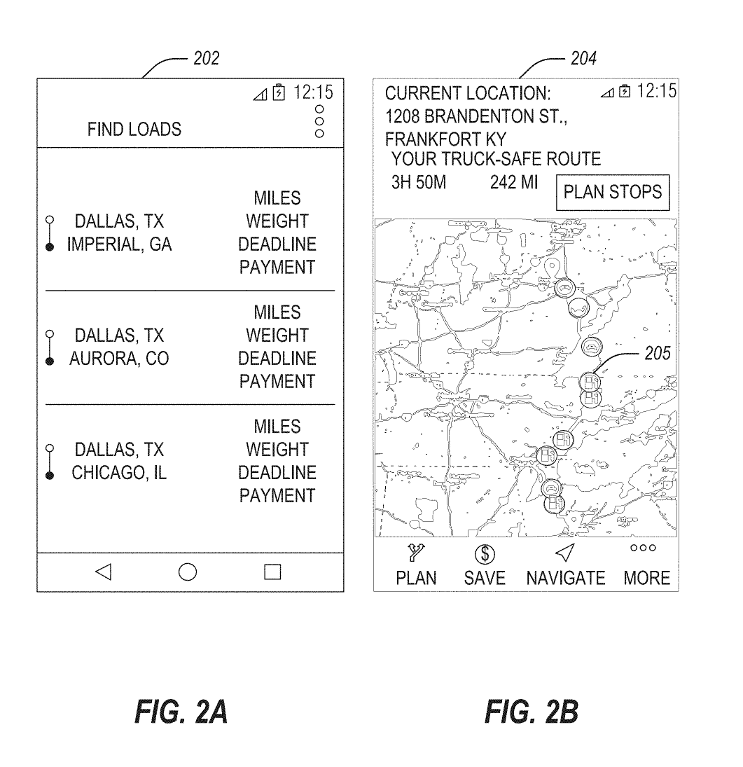

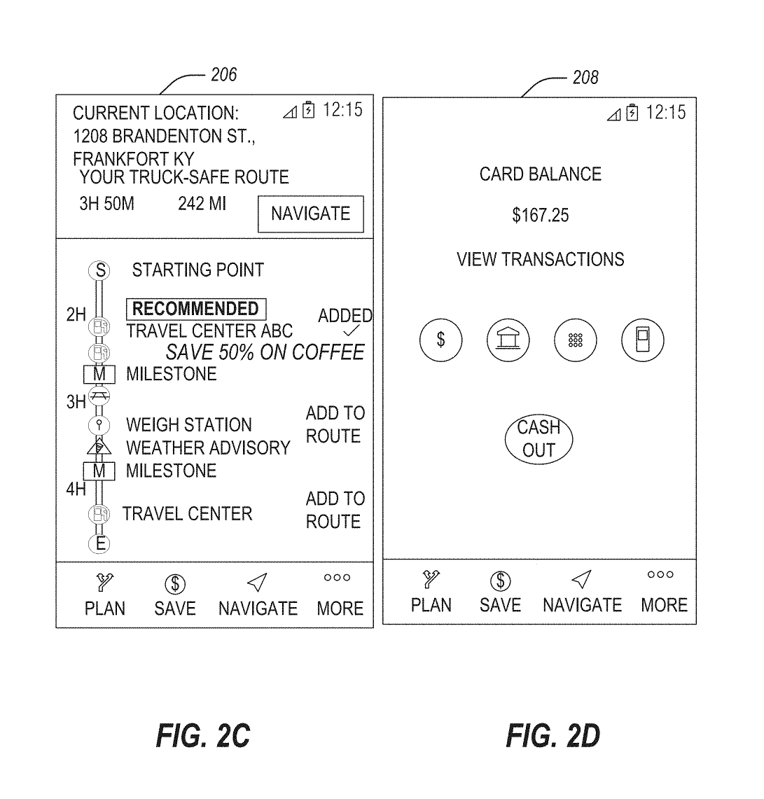

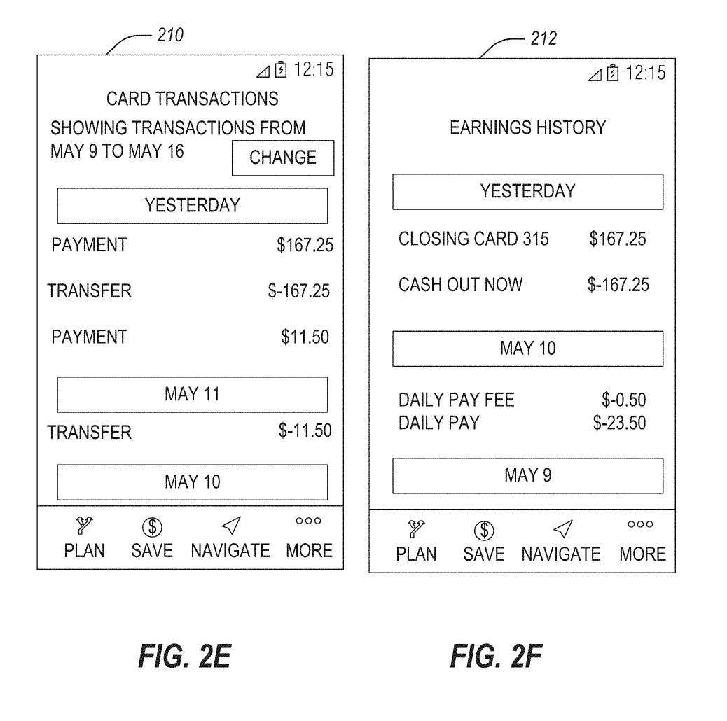

FIGS. 2A-2F illustrate example user interface elements for a progress-based load delivery settlement system in accordance with some embodiments. FIG. 2A illustrates a first user interface element 202, which displays a plurality of loads for selection to a driver. An example load in the plurality of loads may display a point of origin, a destination location, a number of miles, a weight of the load, a deadline for delivery of the load, a settlement or payment for delivery of the load, or the like. A driver or fleet manager may use the first user interface element 202 to select a load to deliver. Once selected, additional information may be provided by the first user interface element 202 related to the load. In an example, the loads displayed in the first user interface element 202 may be sorted or filtered, such as by point of origin, destination, load, payment, etc. After a load is selected, the driver or the fleet manager may select, on the first user interface element 202, to use a progress-based settlement session for the selected load.

FIG. 2B illustrates a second user interface element 204 including a map and route details. The second user interface element 204 includes route duration, route length, a current location, and user selectable options, such as to plan stops, select a point of interest, such as point of interest 205, navigate, etc. The map may illustrate a route (e.g., a truck navigable route, which may be different than a most direct, shortest, or quickest route due to road weight, height, or axel restrictions). The “plan stops” user selectable option allows a driver to select a stop (e.g., from a list), including, for example, fuel stations, rest stops, truck stops, restaurants, etc., any of which may include a rating, accessibility details, deals or discounts (e.g., a digital coupon applicable when a card associated with a progress-based settlement account is used), or the like.

FIG. 2C illustrates a third user interface 206, which includes a route from a starting point to a delivery point with hour markers along the route. The route includes points of interest, such as a travel center ABC, which includes a deal (save 50% on coffee). The travel center ABC may include refueling stations, food, bathrooms, a restaurant, etc. Above the travel center ABC indication, the third user interface 206 includes a “RECOMMENDED” box, which may be used to identify a specific point of interest. The recommended point of interest may be a sponsored point of interest, may be a point of interest with a deal or discount related to use of a card associated with a progress-based settlement account, or a highly rated point of interest (e.g., by other uses of a progress-based settlement service). The travel center ABC is indicated as being already added to the route timeline, which may occur automatically or may be user selected. Additional points of interest may be added to the route as well. Other points of interest include other travel centers, other refueling stations, a weigh station, a weather advisory, road construction, picnic areas, rest stops, truck stops, hotels, or the like. The route may include one or more milestones to indicate a point in the route where a progress-based payment will be made. The milestones or the points of interest may change if the route is changed. The third user interface 206 includes a user selectable option to navigate, which, when selected, may cause the second user interface 204 to be presented with the map as described in FIG. 2B.

FIG. 2D illustrates a fourth user interface 208 that includes a card or account balance. The balance may be a progress-based account or card balance, a balance for a specific session, or an available balance (e.g., for a particular payment type, such as a balance available to be transferred or a balance available to be used to purchase fuel). User selectable options are shown on the fourth user interface 208, including a cash out option to transfer the displayed balance (or a portion thereof) to a bank account, usage history, earning history, a map, an ATM locator, a bank locator, travel history, etc. The fourth user interface 208 may include information on where a percentage payment (e.g., as displayed in a balance) may be spent (e.g., by highlighting/bolding/italicizing available or dimming unavailable options on the second or third user interfaces 204 or 206, or by only displaying available options).

FIG. 2E illustrates a fifth user interface 210 including a transaction history for a progress-based payment account. Payments and transfers are shown on the fourth user interface 208. For example, payments may be milestone progress-based payments during a delivery route. A transfer may include a transfer to a bank account, to a subordinate progress-based settlement account, to cash, to a bill payment, to a card to make purchases with the card, etc. In an example, a subordinate progress-based settlement account may be an account associated with a main account, wherein the main account is for the driver and the subordinate account is for one or more family members or trusted associates of the driver. The main/subordinate account setup allows for a driver to earn money during a route and transfer the money or part of the money to a family member, for example to pay bills or purchase items at home, while the driver is still remote (e.g., during the delivery of the load, or on a return trip). This transfer may be done without fees, with reduced fees compared to a wire transfer, without use of a physical bank branch, or without transferring money from the main account to a bank account. The subordinate account may receive point of interest deals or discounts, which may differ from those offered to the main account. The subordinate account may include a card that may be used as a debit or credit card to withdraw cash or make purchases. An automatic transfer may be setup to release funds from the main account to the subordinate account (e.g., based on a percentage of settlement received).

FIG. 2F illustrates a sixth user interface 212 including an earnings history. The earnings history includes payments or fees associated with a session or an account. In an example, a session may correspond with delivery of a load, and may be closed out at the completion of the delivery (e.g., when delivered or when paperwork is completed). The session may quarantine payments from a main account, such as to restrict payments received during delivery to certain uses. On completion of delivery, the session may release the funds in the session to the main account.

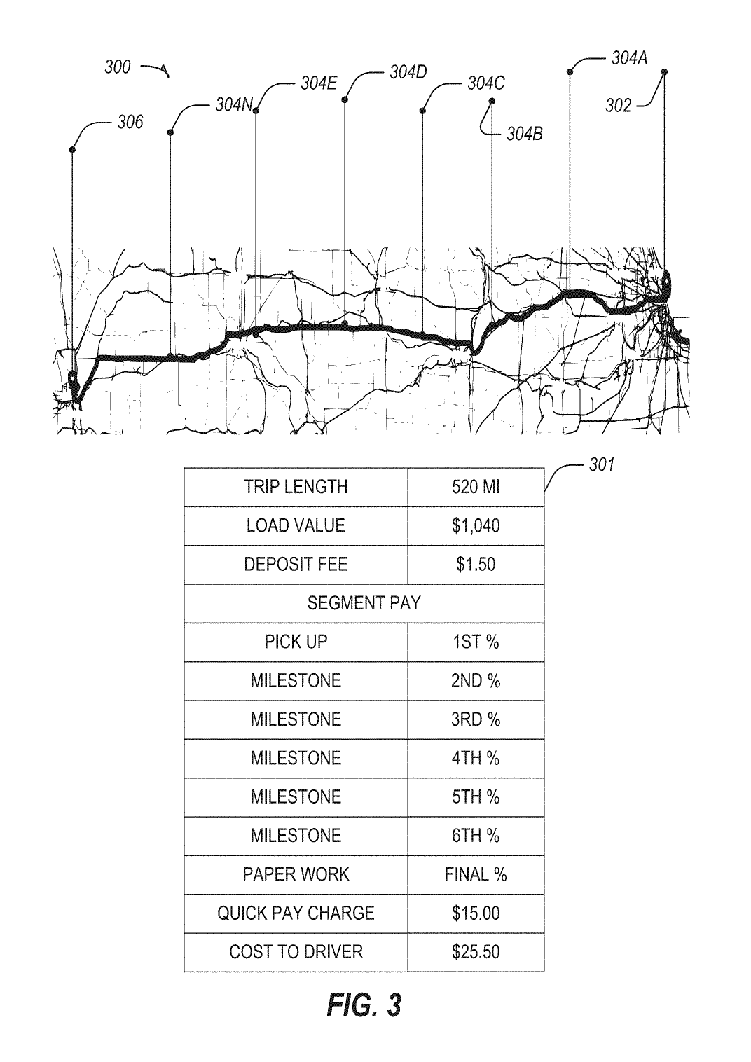

FIG. 3 illustrates an example distribution schedule map 300 and table 301 for progress-based load delivery settlement in accordance with some embodiments. The map 300 includes a series of milestones, including a pickup point 302, milestones 304A-304N, and a delivery endpoint 306. The table 301 includes a total trip length, load value (e.g., total settlement amount to be paid), a deposit fee (e.g., a per payment fee), a plurality of milestones with corresponding payment percentages (to be multiplied by the load value, subject to the deposit fee), any additional charges, and total charges (e.g., to be subtracted from the load value to obtain a total value the driver will receive). The payment percentages illustrated in the table 301 may be unique or may include duplicate percentages. For example, the pickup percentage and the paperwork percentage may each be 20%, with the milestone percentages being the remaining 60% in total. To determine a percentage for each milestone, the 60% may be divided by a number of milestones. The table 301 may include actual payment amounts rather than percentages.

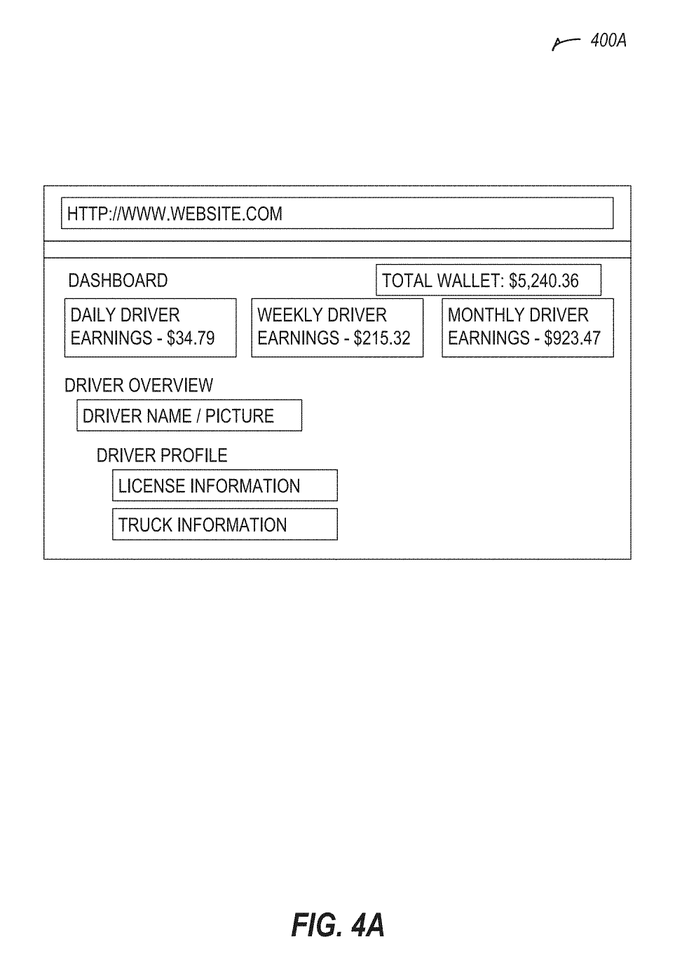

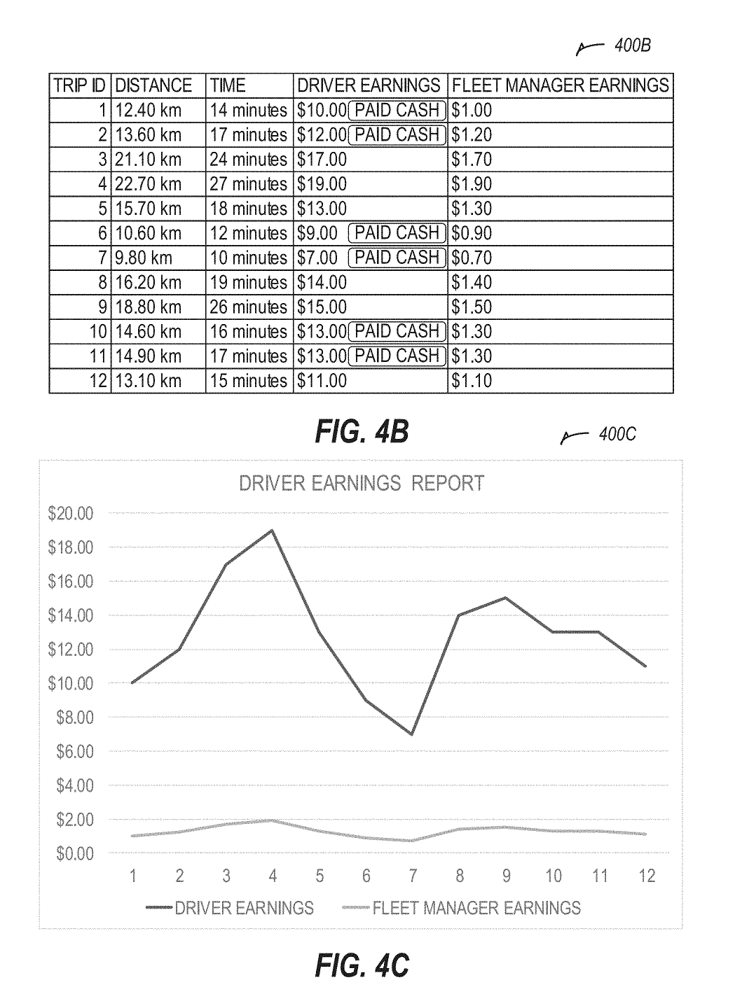

FIGS. 4A-4C illustrate example web-based user interfaces 400A-400C for a progress-based load delivery settlement system in accordance with some embodiments. FIG. 4A illustrates a first user interface 400A including a dashboard section and a driver overview section. The dashboard illustrates earnings, including an account total, and may include daily, weekly, monthly, or yearly earnings. The driver overview may include a driver name or picture, or a driver profile, including for example, license information or truck information. The first user interface 400A may include a current route or load. The first user interface 400A may be used by a fleet manager, and may include options to view different drivers, or may be used by a driver and may include only that driver's information. When used by a fleet manager, the dashboard may include an amount received by the fleet manager from loads delivered by the driver.

FIG. 4B illustrates a second user interface 400B including a trip history with earnings. The trip history shows a plurality of trips (e.g., loads delivered or portions of a route). Each trip may include a distance, time, driver earnings, fleet manager earnings, or the like. In an example, the second user interface 400B may be a fleet manager user interface. In another example, the second user interface 400B may be a driver user interface, such as by excluding the column titled “fleet manager earnings.” The plurality of trips shown in the second user interface 400B include driver earnings, including indications that cash was paid out for some earnings. The indications of “paid cash” may be used when a driver has transferred earnings from a trip to, for example, an account other than a progress-based session main account. For example, a transfer to a bank account, a bill pay service, a subordinate account, etc., may result in the paid cash indication. In another example, earnings used for payment of services or goods (e.g., fuel) may be indicated separately or as “paid cash.”

FIG. 4C illustrates a third user interface 400C including an earnings report chart. The earnings report chart may include driver earnings, fleet manager earnings, or both (e.g., just driver earnings for a driver view, or just the fleet manager earnings or both for a fleet manager view). In an example, the driver earnings report in third user interface 400C may correspond to information from the second user interface 400B.

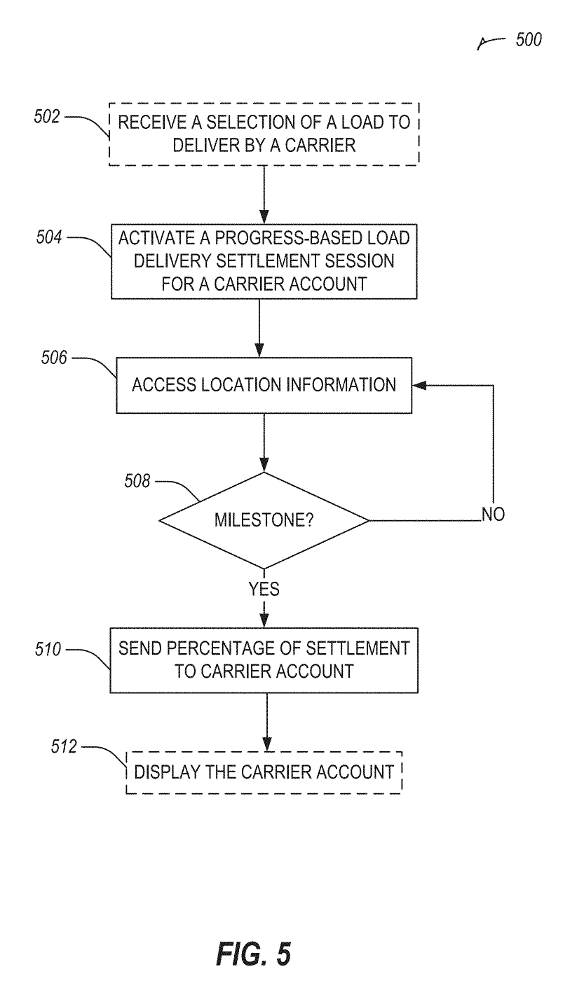

FIG. 5 illustrates a flowchart showing a technique 500 for progress-based load delivery settlement at a local device in accordance with some embodiments. The technique 500 includes an optional operation 502 to receive a selection of a load to deliver by a carrier. For example, a driver may select a load on a user interface (e.g., from a plurality of displayed loads), and the user interface may forward the selection to a progress-based payment entity. The user interface may be displayed, for example, on an app of a mobile device or on a website. In an example, when the carrier selects the load, an indication of a total value of the settlement may be sent to the progress-based payment entity. Percentages of the settlement to send to the carrier account at a plurality of milestones may be determined.

The technique 500 includes an operation 504 to activate a progress-based load delivery settlement session for a carrier account. In an example, the carrier account may correspond to the driver. The progress-based load delivery settlement session may include a notice of assignment of a settlement (e.g., proceeds of a contract for delivery of the load) to the progress-based payment entity. The technique 500 includes an operation 506 to access location information. The location information may be determined using a global positioning system (GPS) unit, such as located on a truck driving the load, with the load, with the driver (e.g., a mobile device), etc., a landmark (e.g., a weigh station), or other location based services.

The technique 500 includes a decision operation 508 to determine whether the driver and the load has passed a milestone. When no milestone has been passed, the technique 500 may return to operation 506. When a milestone has been passed, the technique 500 includes an operation 510 to send a percentage of settlement to the carrier account. For example, when the driver picks up the load, a first milestone may be triggered, and a first percentage of the settlement may be paid to the session of the carrier account. When the driver passes a number of miles (e.g., 100 miles), such as along a route from a pickup location to a delivery location of the load, a milestone may be passed and a second percentage of the settlement may be paid to the session of the carrier account. As other milestones are passed, additional payments may be made. A milestone may include final delivery of the load or completion of paperwork related to delivery of the load.

The technique 500 may include an operation 512 to display the carrier account, such as on a user interface an app of a mobile device or a website. Displaying the carrier account may include displaying at least one subordinate account. An option may be available on the user interface to transfer a portion of the first or second percentage (including, optionally an entire amount) of the settlement received to the at least one subordinate account. An automatic transfer may be generated, such as to automatically transfer a specified portion (e.g., half) of a particular percentage of the settlement received when the particular percentage is received or when any percentage is received. In an example, a payment processing fee may be generated and sent to the progress-based payment entity in response to a percentage of the settlement being sent to the carrier. In an example, the technique 500 may include receiving a request to transfer a portion of the settlement to at least one subordinate account. The technique 500 may include determining whether the portion of the settlement is transferrable. For example, to determine whether the portion of the settlement is transferrable may include determining whether the portion of the settlement has been transferred to the carrier account or determining whether the at least one subordinate account is authorized to receive a transfer from the carrier account. The technique 500 may include, in response to determining that the portion of the settlement is transferrable, transferring the portion of the settlement from the carrier account to the at least one subordinate account.

The technique 500 may include displaying the user interface including a map or a list. The map or the list may include information about a route to deliver the load. The route may be a carrier-navigable route, such as one that includes roads navigable by a truck driven to deliver the load and excludes roads that are unnavigable (e.g., due to weight restrictions, size restrictions, axel restrictions, etc.). The route may be generated based on weather or traffic information. The route may start at a pickup location of the load and end at a delivery location of the load. The map or list may include a point of interest, such as based on a location of the carrier (e.g., during the route). The point of interest may include a location to purchase items, such as fuel, a truck stop, a rest stop, a weather-related event, a traffic-related event, or the like. In an example, the first or second percentage of the settlement may be restricted to a point of interest, and an indication of such may be displayed on the map or list.

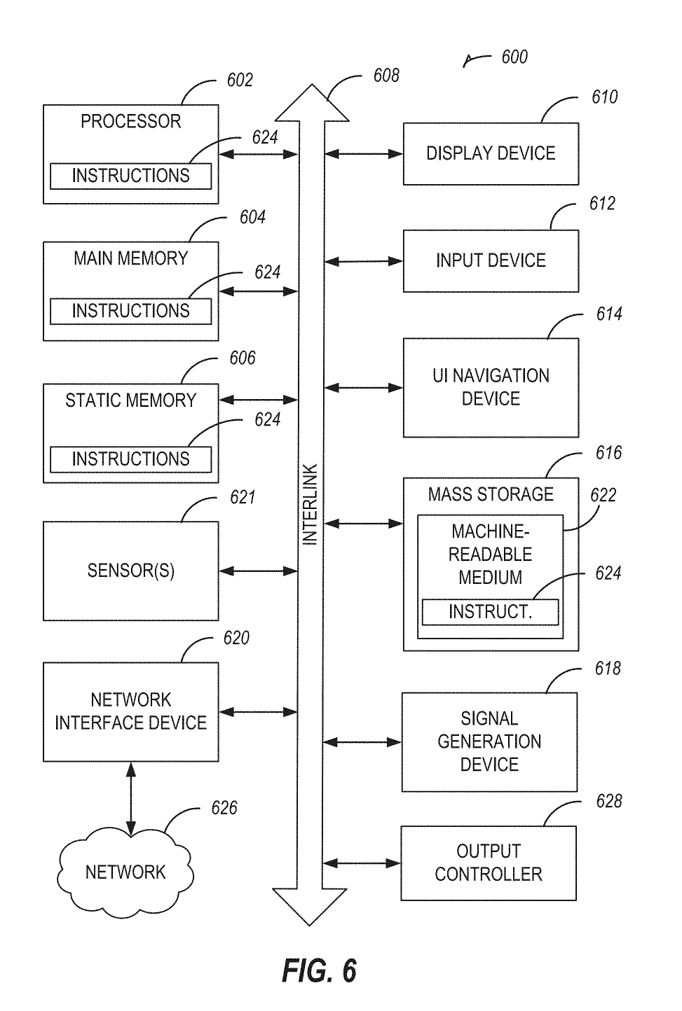

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc. and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc. connection to communicate or control one or more peripheral devices (e.g., a printer, card reader, etc.

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### VARIOUS NOTES & EXAMPLES

Each of these non-limiting examples may stand on its own, or may be combined in various permutations or combinations with one or more of the other examples.

Example 1 is a method for progress-based load delivery settlement, the method comprising: receiving, on a user interface, a selection of a load to deliver by a carrier; activating a progress-based load delivery settlement session for a carrier account corresponding to the carrier; accessing information from a GPS unit corresponding to the carrier delivering the load; receiving, in response to the GPS unit sending information indicating that the load has been picked up by the carrier, a first percentage of a settlement in a carrier account; receiving, in response to the GPS unit sending information indicating that the carrier has passed a first milestone, a second percentage of the settlement in the carrier account; and displaying the carrier account, including a percentage of the settlement received on the user interface.

In Example 2, the subject matter of Example 1 includes, wherein receiving the selection includes displaying, on the user interface, a plurality of loads for selection including the load.

In Example 3, the subject matter of Examples 1-2 includes, wherein the user interface is displayed on a mobile app or a website.

In Example 4, the subject matter of Examples 1-3 includes, displaying a map on the user interface, the map including a route to deliver the load, wherein the route is a carrier-navigable route from a point of pickup of the load to a point of delivery of the load.

In Example 5, the subject matter of Example 4 includes, wherein the map includes at least one point of interest based on a location of the carrier.

In Example 6, the subject matter of Example 5 includes, wherein receiving the second percentage of the settlement in the carrier account includes restricting use of the second percentage of the settlement in the carrier account to purchases made at the at least one point of interest, and wherein displaying the percentage of the settlement received includes displaying an indication that the second percentage of the settlement can be spent at the at least one point of interest.

In Example 7, the subject matter of Examples 4-6 includes, presenting, on e user interface, a carrier account linked offer based on the location of the carrier.

In Example 8, the subject matter of Examples 4-7 includes, wherein the map includes a milestone indication, the milestone indication based on a total mileage of the route.

In Example 9, the subject matter of Examples 1-8 includes, receiving a user indication that the load has been delivered.

In Example 10, the subject matter of Example 9 includes, sending the user indication to a processing server.

In Example 11, the subject matter of Example 10 includes, receiving, in response to sending the user indication, a third percentage of the settlement in the carrier account, the third percentage of the settlement equal to the second percentage of the settlement.

In Example 12, the subject matter of Examples 10-11 includes, wherein sending the indication to the processing server includes sending instructions to transfer an amount of the carrier account to a bank account, and transferring the amount to the bank account.

In Example 13, the subject matter of Examples 1-12 includes, receiving, in response to paper-work related to delivery of the load being accepted, a remaining percentage of the settlement in the carrier account.

In Example 14, the subject matter of Examples 1-13 includes, wherein the first and second milestones are equal to a predetermined distance.

In Example 15, the subject matter of Examples 1-14 includes, receiving, in response to the GPS unit sending information indicating that the carrier has passed a second milestone, a second payment equal in value to the second percentage of the settlement to the carrier account.

In Example 16, the subject matter of Examples 1-15 includes, wherein displaying the carrier account includes displaying at least one subordinate account and displaying an option to transfer a portion of the percentage of the settlement received to the at least one subordinate account.

Example 17 is a device for progress-based load delivery settlement, the device comprising: a display; a processor and memory including instructions, which when executed by the processor, cause the processor to: receive, via a user interface of the display, a selection of a load to deliver by a carrier; activate a progress-based load delivery settlement session for a carrier account corresponding to the carrier; access information from a GPS unit corresponding to the carrier delivering the load; receive, in response to the GPS unit sending information indicating that the load has been picked up by the carrier, a first percentage of a settlement in a carrier account; receive, in response to the GPS unit sending information indicating that the carrier has passed a first milestone, a second percentage of the settlement in the carrier account; and display the carrier account, including a percentage of the settlement received on the user interface.

In Example 18, the subject matter of Example 17 includes, wherein the instructions to receive the selection further cause the processor to display, on the user interface, a plurality of loads for selection including the load.

In Example 19, the subject matter of Examples 17-18 includes, wherein the device is a mobile device and wherein the user interface is displayed on a mobile app of the mobile device.

In Example 20, the subject matter of Examples 17-19 includes, wherein the instructions further cause the processor to display a map on the user interface, the map including a route to deliver the load, wherein the route is a carrier-navigable route from a point of pickup of the load to a point of delivery of the load.

In Example 21, the subject matter of Example 20 includes, wherein the map includes at least one point of interest based on a location of the carrier.

In Example 22, the subject matter of Example 21 includes, wherein the instructions to receive the second percentage of the settlement in the carrier account include instructions to restrict use of the second percentage of the settlement in the carrier account to purchases made at the at least one point of interest, and wherein the instructions to display the percentage of the settlement received include instructions to display an indication that the second percentage of the settlement can be spent at the at least one point of interest.

In Example 23, the subject matter of Examples 20-22 includes, wherein the instructions further cause the processor to present, on the user interface, a carrier account linked offer based on the location of the carrier.

In Example 24, the subject matter of Examples 20-23 includes, wherein the map includes a milestone indication, the milestone indication based on a total mileage of the route.

In Example 25, the subject matter of Examples 17-24 includes, wherein the instructions further cause the processor to receive a user indication that the load has been delivered.

In Example 26, the subject matter of Example 25 includes, wherein the instructions further cause the processor to send the user indication to a processing server.

In Example 27, the subject matter of Example 26 includes, wherein the instructions further cause the processor to receive, in response to sending the user indication, a third percentage of the settlement in the carrier account, the third percentage of the settlement equal to the second percentage of the settlement.

In Example 28, the subject matter of Examples 26-27 includes, wherein the instructions to send the indication to the processing server further cause the processor to send instructions to transfer an amount of the carrier account to a bank account, and transferring the amount to the bank account.

In Example 29, the subject matter of Examples 17-28 includes, wherein the instructions further cause the processor to receive, in response to paper-work related to delivery of the load being accepted, a remaining percentage of the settlement in the carrier account.

In Example 30, the subject matter of Examples 17-29 includes, wherein the first and second milestones are equal to a predetermined distance.

In Example 31, the subject matter of Examples 17-30 includes, wherein the instructions further cause the processor to receive, in response to the GPS unit sending information indicating that the carrier has passed a second milestone, a second payment equal in value to the second percentage of the settlement to the carrier account.

In Example 32, the subject matter of Examples 17-31 includes, wherein the instructions to display the carrier account include instructions to display at least one subordinate account and display an option to transfer a portion of the percentage of the settlement received to the at least one subordinate account.

Example 33 is at least one non-transitory machine-readable medium including instructions for progress-based load delivery settlement, which when performed by a processor, cause the processor to: receive, via a user interface of the display, a selection of a load to deliver by a carrier; activate a progress-based load delivery settlement session for a carrier account corresponding to the carrier; access information from a GPS unit corresponding to the carrier delivering the load; receive, in response to the GPS unit sending information indicating that the load has been picked up by the carrier, a first percentage of a settlement in a carrier account; receive, in response to the GPS unit sending information indicating that the carrier has passed a first milestone, a second percentage of the settlement in the carrier account; and display the carrier account, including a percentage of the settlement received on the user interface.

In Example 34, the subject matter of Example 33 includes, wherein the instructions to receive the selection further cause the processor to display, on the user interface, a plurality of loads for selection including the load.

In Example 35, the subject matter of Examples 33-34 includes, wherein the device is a mobile device and wherein the user interface is displayed on a mobile app of the mobile device.

In Example 36, the subject matter of Examples 33-35 includes, wherein the instructions further cause the processor to display a map on the user interface, the map including a route to deliver the load, wherein the route is a carrier-navigable route from a point of pickup of the load to a point of delivery of the load.

In Example 37, the subject matter of Example 36 includes, wherein the map includes at least one point of interest based on a location of the carrier.

In Example 38, the subject matter of Example 37 includes, wherein the instructions to receive the second percentage of the settlement in the carrier account include instructions to restrict use of the second percentage of the settlement in the carrier account to purchases made at the at least one point of interest, and wherein the instructions to display the percentage of the settlement received include instructions to display an indication that the second percentage of the settlement can be spent at the at least one point of interest.

In Example 39, the subject matter of Examples 36-38 includes, wherein the instructions further cause the processor to present, on the user interface, a carrier account linked offer based on the location of the carrier.

In Example 40, the subject matter of Examples 36-39 includes, wherein the map includes a milestone indication, the milestone indication based on a total mileage of the route.

In Example 41, the subject matter of Examples 33-40 includes, wherein the instructions further cause the processor to receive a user indication that the load has been delivered.

In Example 42, the subject matter of Example 41 includes, wherein the instructions further cause the processor to send the user indication to a processing server.

In Example 43, the subject matter of Example 42 includes, wherein the instructions further cause the processor to receive, in response to sending the user indication, a third percentage of the settlement in the carrier account, the third percentage of the settlement equal to the second percentage of the settlement.

In Example 44, the subject matter of Examples 42-43 includes, wherein the instructions to send the indication to the processing server further cause the processor to send instructions to transfer an amount of the carrier account to a bank account, and transferring the amount to the bank account.

In Example 45, the subject matter of Examples 33-44 includes, wherein the instructions further cause the processor to receive, in response to paper-work related to delivery of the load being accepted, a remaining percentage of the settlement in the carrier account.

In Example 46, the subject matter of Examples 33-45 includes, wherein the first and second milestones are equal to a predetermined distance.

In Example 47, the subject matter of Examples 33-46 includes, wherein the instructions further cause the processor to receive, in response to the GPS unit sending information indicating that the carrier has passed a second milestone, a second payment equal in value to the second percentage of the settlement to the carrier account.

In Example 48, the subject matter of Examples 33-47 includes, wherein the instructions to display the carrier account include instructions to display at least one subordinate account and display an option to transfer a portion of the percentage of the settlement received to the at least one subordinate account.

Example 49 is a method for progress-based load delivery settlement, the method comprising: receiving an indication that a carrier has accepted a load to deliver; activating a progress-based load delivery settlement session for a carrier account corresponding to the carrier; receiving an indication that the load has been picked up by the carrier; transmitting, in response to receiving the indication that the load has been picked up by the carrier, a first percentage of a settlement to the carrier account; determining, based on information received from a GPS unit operated by the carrier while transporting the load, that the carrier has passed a first milestone; and transmitting, in response to determining that the carrier has passed a first milestone, a second percentage of the settlement to the carrier account.

In Example 50, the subject matter of Example 49 includes, determining that the load has been delivered.

In Example 51, the subject matter of Example 50 includes, transmitting, in response to determining that the load has been delivered, a third percentage of the settlement to the carrier account, the third percentage of the settlement equal to the second percentage of the settlement.

In Example 52, the subject matter of Examples 49-51 includes, receiving an indication that paper-work related to delivery of the load has been accepted.

In Example 53, the subject matter of Example 52 includes, transmitting, in response to receiving the indication that paper-work related to delivery of the load has been accepted, a remaining percentage of the settlement to the carrier account.

In Example 54, the subject matter of Examples 49-53 includes, wherein the first milestone is equal to a predetermined distance traveled by the carrier while transporting the load toward an endpoint.

In Example 55, the subject matter of Examples 49-54 includes, transmitting a payment processing fee to a payment processing entity for each percentage transmitted.

In Example 56, the subject matter of Example 55 includes, wherein the payment processing fee is a fixed fee.

In Example 57, the subject matter of Examples 49-56 includes, wherein receiving the indication that the carrier has accepted the load to deliver includes receiving an indication of a total value of the settlement and further comprising determining percentages of the settlement to send to the carrier account at a plurality of milestones.

In Example 58, the subject matter of Examples 49-57 includes, determining, based on information received from a GPS unit operated by the carrier while transporting the load, that the carrier has passed a second milestone; and transmitting, in response to determining that the carrier has passed the second milestone, a second payment equal in value to the second percentage of the settlement to the carrier account.

In Example 59, the subject matter of Examples 49-58 includes, sending at least one point of interest along a route based on a location of the carrier to the carrier for display, wherein the route is a carrier-navigable route from a point of pickup of the load to a point of delivery of the load.

In Example 60, the subject matter of Example 59 includes, wherein transmitting the second percentage of the settlement to the carrier account includes restricting use of the second percentage of the settlement in the carrier account to purchases made at the at least one point of interest.

In Example 61, the subject matter of Examples 59-60 includes, wherein sending the at least one point of interest includes sending a carrier account linked offer based on the location of the carrier corresponding to the at least one point of interest.

In Example 62, the subject matter of Examples 49-61 includes, receiving a request to transfer a portion of the settlement to at least one subordinate account; determining whether the portion of the settlement is transferrable; in response to determining that the portion of the settlement is transferrable, transferring the portion of the settlement from the carrier account to the at least one subordinate account.

In Example 63, the subject matter of Example 62 includes, wherein determining whether the portion of the settlement is transferrable includes determining whether the portion of the settlement has been transferred to the carrier account and determining whether the at least one subordinate account is authorized to receive a transfer from the carrier account.

Example 64 is a device for progress-based load delivery settlement, the device comprising: a display; a processor and memory including instructions, which when executed by the processor, cause the processor to: receive an indication that a carrier has accepted a load to deliver; activate a progress-based load delivery settlement session for a carrier account corresponding to the carrier; receive an indication that the load has been picked up by the carrier; transmit, in response to receiving the indication that the load has been picked up by the carrier, a first percentage of a settlement to the carrier account; determine, based on information received from a GPS unit operated by the carrier while transporting the load, that the carrier has passed a first milestone; and transmit, in response to determining that the carrier has passed a first milestone, a second percentage of the settlement to the carrier account.

In Example 65, the subject matter of Example 64 includes, wherein the instructions further cause the processor to determine that the load has been delivered.

In Example 66, the subject matter of Example 65 includes, wherein the instructions further cause the processor to transmit, in response to determining that the load has been delivered, a third percentage of the settlement to the carrier account, the third percentage of the settlement equal to the second percentage of the settlement.

In Example 67, the subject matter of Examples 64-66 includes, wherein the instructions further cause the processor to receive an indication that paper-work related to delivery of the load has been accepted.

In Example 68, the subject matter of Example 67 includes, wherein the instructions further cause the processor to transmit, in response to receiving the indication that paper-work related to delivery of the load has been accepted, a remaining percentage of the settlement to the carrier account.

In Example 69, the subject matter of Examples 64-68 includes, wherein the first milestone is equal to a predetermined distance traveled by the carrier while transporting the load toward an endpoint.

In Example 70, the subject matter of Examples 64-69 includes, wherein the instructions further cause the processor to transmit a payment processing fee to a payment processing entity for each percentage transmitted.

In Example 71, the subject matter of Example 70 includes, wherein the payment processing fee is a fixed fee.

In Example 72, the subject matter of Examples 64-71 includes, wherein the instructions to receive the indication that the carrier has accepted the load to deliver further cause the processor to receive an indication of a total value of the settlement and wherein the instructions further cause the processor to determine percentages of the settlement to send to the carrier account at a plurality of milestones.

In Example 73, the subject matter of Examples 64-72 includes, wherein the instructions further cause the processor to: determine, based on information received from a GPS unit operated by the carrier while transporting the load, that the carrier has passed a second milestone; and transmit, in response to determining that the carrier has passed the second milestone, a second payment equal in value to the second percentage of the settlement to the carrier account.

In Example 74, the subject matter of Examples 64-73 includes, wherein the instructions further cause the processor to send at least one point of interest along a route based on a location of the carrier to the carrier for display, and wherein the route is a carrier-navigable route from a point of pickup of the load to a point of delivery of the load.

In Example 75, the subject matter of Example 74 includes, wherein the instructions to transmit the second percentage of the settlement to the carrier account include instructions to restrict use of the second percentage of the settlement in the carrier account to purchases made at the at least one point of interest.

In Example 76, the subject matter of Examples 74-75 includes, wherein the instructions to send the at least one point of interest include instructions to send a carrier account linked offer based on the location of the carrier corresponding to the at least one point of interest.

In Example 77, the subject matter of Examples 64-76 includes, wherein the instructions further cause the processor to: receive a request to transfer a portion of the settlement to at least one subordinate account; determine whether the portion of the settlement is transferrable; in response to determining that the portion of the settlement is transferrable, transfer the portion of the settlement from the carrier account to the at least one subordinate account.

In Example 78, the subject matter of Example 77 includes, wherein the instructions to determine whether the portion of the settlement is transferrable include instructions to determine whether the portion of the settlement has been transferred to the carrier account and determine whether the at least one subordinate account is authorized to receive a transfer from the carrier account.

Example 79 is at least one non-transitory machine-readable medium including instructions for progress-based load delivery settlement, which when performed by a processor, cause the processor to: receive an indication that a carrier has accepted a load to deliver; activate a progress-based load delivery settlement session for a carrier account corresponding to the carrier; receive an indication that the load has been picked up by the carrier; transmit, in response to receiving the indication that the load has been picked up by the carrier, a first percentage of a settlement to the carrier account; determine, based on information received from a GPS unit operated by the carrier while transporting the load, that the carrier has passed a first milestone; and transmit, in response to determining that the carrier has passed a first milestone, a second percentage of the settlement to the carrier account.

In Example 80, the subject matter of Example 79 includes, wherein the instructions further cause the processor to determine that the load has been delivered.

In Example 81, the subject matter of Example 80 includes, wherein the instructions further cause the processor to transmit, in response to determining that the load has been delivered, a third percentage of the settlement to the carrier account, the third percentage of the settlement equal to the second percentage of the settlement.

In Example 82, the subject matter of Examples 79-81 includes, wherein the instructions further cause the processor to receive an indication that paper-work related to delivery of the load has been accepted.

In Example 83, the subject matter of Example 82 includes, wherein the instructions further cause the processor to transmit, in response to receiving the indication that paper-work related to delivery of the load has been accepted, a remaining percentage of the settlement to the carrier account.

In Example 84, the subject matter of Examples 79-83 includes, wherein the first milestone is equal to a predetermined distance traveled by the carrier while transporting the load toward an endpoint.

In Example 85, the subject matter of Examples 79-84 includes, wherein the instructions further cause the processor to transmit a payment processing fee to a payment processing entity for each percentage transmitted.

In Example 86, the subject matter of Example 85 includes, wherein the payment processing fee is a fixed fee.

In Example 87, the subject matter of Examples 79-86 includes, wherein the instructions to receive the indication that the carrier has accepted the load to deliver further cause the processor to receive an indication of a total value of the settlement and wherein the instructions further cause the processor to determine percentages of the settlement to send to the carrier account at a plurality of milestones.

In Example 88, the subject matter of Examples 79-87 includes, wherein the instructions further cause the processor to: determine, based on information received from a GPS unit operated by the carrier while transporting the load, that the carrier has passed a second milestone; and transmit, in response to determining that the carrier has passed the second milestone, a second payment equal in value to the second percentage of the settlement to the carrier account.

In Example 89, the subject matter of Examples 79-88 includes, wherein the instructions further cause the processor to send at least one point of interest along a route based on a location of the carrier to the carrier for display, and wherein the route is a carrier-navigable route from a point of pickup of the load to a point of delivery of the load.

In Example 90, the subject matter of Example 89 includes, wherein the instructions to transmit the second percentage of the settlement to the carrier account include instructions to restrict use of the second percentage of the settlement in the carrier account to purchases made at the at least one point of interest.

In Example 91, the subject matter of Examples 89-90 includes, wherein the instructions to send the at least one point of interest include instructions to send a carrier account linked offer based on the location of the carrier corresponding to the at least one point of interest.

In Example 92, the subject matter of Examples 79-91 includes, wherein the instructions further cause the processor to: receive a request to transfer a portion of the settlement to at least one subordinate account; determine whether the portion of the settlement is transferrable; in response to determining that the portion of the settlement is transferrable, transfer the portion of the settlement from the carrier account to the at least one subordinate account.

In Example 93, the subject matter of Example 92 includes, wherein the instructions to determine whether the portion of the settlement is transferrable include instructions to determine whether the portion of the settlement has been transferred to the carrier account and determine whether the at least one subordinate account is authorized to receive a transfer from the carrier account.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks compact disks and digital video disks), magnetic cassettes, memory cards or sticks, random access memories (RAMS), read only memories (ROMs), and the like.

What is claimed is:

1. A device for progress-based load delivery settlement, the device comprising:
a display;
a processor and memory including instructions, which when executed by the processor, cause the processor to:
receive, via a user interface of the display, a selection of a load to deliver by a carrier;
activate a progress-based load delivery settlement session for a carrier account corresponding to the carrier;
access information from a global positioning system (GPS) unit, the information corresponding to the carrier delivering the load;
receive, in response to receiving the information indicating that the load has been picked up by the carrier, a first percentage of a settlement in a carrier account;
receive, in response to the GPS unit sending information indicating that the carrier has passed a first milestone, a second percentage of the settlement in the carrier account; and
display the carrier account, including the first percentage of the settlement received on the user interface.

2. The device of claim 1, further comprising instructions to cause the processor to display, on the user interface, a plurality of loads for selection, and wherein the instructions to receive the selection further cause the processor to receive the selection from among the plurality of loads.

3. The device of claim 1, wherein the device is a mobile device and wherein the user interface is displayed on a mobile app of the mobile device.

4. The device of claim 1, wherein the instructions further cause the processor to display a map on the user interface, the map including a route to deliver the load, wherein the route is a carrier-navigable route from a pickup point of the load to a delivery point of the load.

5. The device of claim 4, wherein the map includes at least one point of interest based on a location of the carrier.

6. The device of claim 5, wherein the instructions to receive the second percentage of the settlement in the carrier account include instructions to restrict use of the second percentage of the settlement in the carrier account to purchases made at the at least one point of interest; and
wherein the instructions to display the first percentage of the settlement received include instructions to display an indication that the second percentage of the settlement can be spent at the at least one point of interest.

7. The device of claim 1, wherein the instructions further cause the processor to receive, in response to paper-work related to delivery of the load being accepted, a remaining percentage of the settlement in the carrier account.

8. The device of claim 1, wherein the first milestone is equal to a predetermined distance.

9. The device of claim 1, wherein the instructions further cause the processor to receive, in response to the GPS unit sending information indicating that the carrier has passed a second milestone, a second payment equal in value to the second percentage of the settlement to the carrier account.

10. At least one non-transitory machine-readable medium including instructions for progress-based load delivery settlement, which when performed by a processor, cause the processor to:
receive an indication that a carrier has accepted a load to deliver;
activate a progress-based load delivery settlement session for a carrier account corresponding to the carrier;
receive an indication that the load has been picked up by the carrier;
transmit, in response to receiving the indication that the load has been picked up by the carrier, a first percentage of a settlement to the carrier account;
determine, based on information recorded by a global positioning system (GPS) unit operated by the carrier while transporting the load, that the carrier has passed a first milestone; and
transmit, in response to determining that the carrier has passed a first milestone, a second percentage of the settlement to the carrier account.

11. The at least one non-transitory machine-readable medium of claim 10, wherein the instructions further cause the processor to determine that the load has been delivered and transmit, in response to determining that the load has been delivered, a third percentage of the settlement to the carrier account, the third percentage of the settlement equal to the second percentage of the settlement.

12. The at least one non-transitory machine-readable medium of claim 10, wherein the instructions further cause the processor to receive an indication that paper-work related to delivery of the load has been accepted and transmit, in response to receiving the indication that paper-work related to delivery of the load has been accepted, a remaining percentage of the settlement to the carrier account.

13. The at least one non-transitory machine-readable medium of claim 10, wherein the first milestone is equal to a predetermined distance traveled by the carrier while transporting the load toward an endpoint.

14. The at least one non-transitory machine-readable medium of claim 10, wherein the instructions to receive the indication that the carrier has accepted the load to deliver further cause the processor to receive an indication of a total value of the settlement and wherein the instructions further cause the processor to determine percentages of the settlement to send to the carrier account at a plurality of milestones.

15. The at least one non-transitory machine-readable medium of claim 10, wherein the instructions further cause the processor to:
determine, based on information recorded by the GPS unit operated by the carrier while transporting the load, that the carrier has passed a second milestone; and
transmit, in response to determining that the carrier has passed the second milestone, a second payment equal in value to the second percentage of the settlement to the carrier account.

16. The at least one non-transitory machine-readable medium of claim 10, wherein the instructions further cause the processor to send at least one point of interest along a route based on a location of the carrier to the carrier for display, and wherein the route is a carrier-navigable route from a point of pickup of the load to a point of delivery of the load.

17. The at least one non-transitory machine-readably medium of claim 16, wherein the instructions to transmit the second percentage of the settlement to the carrier account include instructions to restrict use of the second percentage of the settlement in the carrier account to purchases made at the at least one point of interest.

18. The at least one non-transitory machine-readable medium of claim 16, wherein the instructions to send the at least one point of interest include instructions to send a carrier account linked offer based on the location of the carrier corresponding to the at least one point of interest.

19. The at least one non-transitory machine-rea medium of claim 10, wherein the instructions further cause the processor to:
receive a request to transfer a portion of the settlement to at least one subordinate account;
determine whether the portion of the settlement is transferrable;
in response to determining that the portion of the settlement is transferrable, transfer the portion of the settlement from the carrier account to the at least one subordinate account.

20. The at least one non-transitory machine-readable medium of claim 19, wherein the instructions to determine whether the portion of the settlement is transferrable include instructions to determine whether the portion of the settlement has been transferred to the carrier account and determine whether the at least one subordinate account is authorized to receive a transfer from the carrier account.
